(19) United States
(12) Patent Application Publication
(10) Pub. No.: US 2011/0107392 A1
(43) Pub. Date: May 5, 2011

(54) MANAGEMENT OF OBSERVABLE COLLECTIONS OF VALUES

(75) Inventors: Henricus Johannes Maria Meijer, Mercer Island, WA (US); John Wesley Dyer, Monroe, WA (US)

(73) Assignee: Microsoft Corporation, Redmond, WA (US)

(21) Appl. No.: 12/612,696

(22) Filed: Nov. 5, 2009

(51) Int. Cl. H04L 9/00

(52) U.S. Cl. 726/1

(57) ABSTRACT

Architecture that a mathematical duality established herein between an asynchronous observable design pattern and a synchronous iterator design pattern. This provides a mechanism for processing multiple observable collection and asynchronous values associated with those collections, including situations where a single observable collection is directed to multiple subscribers or multiple observable collections are directed to a single subscriber. Operators are presented that facilitate multi-collection processing based on this proven duality. As a result of this duality concurrent asynchronous and event-driven programs can be elegantly formulated. Consequently, asynchronous and event-based programming can now be unified into single conceptual framework, based on sound mathematical principles such as monads and duality.

### BACKGROUND

Current languages and libraries provide little support for asynchronous and event-based programming. This forces developers to use an explicit continuation passing style by breaking code into many disjointed event-handlers. The lack of an accessible programming model for asynchronous programming is quickly becoming problematic for developers because of the inevitable advent of multi-core computers, distributed computing, and cloud computing, for example for which asynchronous programming is a necessity.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture leverages the mathematical duality established herein between an asynchronous observable design pattern and a synchronous iterator design pattern. Moreover, this provides a mechanism for processing multiple push-based streams (also referred to as observable collections) and values associated with those streams. This includes, for example, situations where a single push-based stream is directed to multiple subscribers or multiple push-based streams are directed to a single subscriber. Operators are presented that facilitate multi-stream processing based on this proven duality.

As a result of this duality concurrent asynchronous and event-driven programs can be elegantly formulated (e.g., using standard language integrated query (LINQ) query comprehensions). Consequently, asynchronous and event-based programming can be unified into single conceptual framework, based on sound mathematical principles such as monads and duality.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented processing system for observable collections in accordance with the disclosed architecture.

FIG. 2 illustrates mechanisms for composing observable collections and policies that can apply to each mechanism.

FIG. 3 illustrates a diagram that represents a Select operator for observable collections.

FIG. 4 illustrates a diagram that represents the effect of a Flatten operator for observable collections.

FIG. 5 illustrates a diagram for a replace strategy where a previous observable collection is forwarded until a next observable collection starts.

FIG. 6 illustrates a diagram of yet another approach to flattening nested observable collections by buffering subsequent collections until the collections streams have terminated.

FIG. 7 illustrates a diagram for an Until operator that can be used to implement the above mentioned strategies for flattening nested observable collections.

FIG. 8 illustrates a diagram for handling errors.

FIG. 9 illustrates a diagram for a Share operator.

FIG. 10 illustrates a diagram for a Next operator.

FIG. 11 illustrates a diagram for operation of the disclosed Tarzan algorithm.

FIG. 12 illustrates a diagram of a more specific implementation of a SelectMany operator.

FIG. 13 illustrates a diagram of a SelectMany operator that functions as a broadcast operation.

FIG. 14 illustrates a diagram of a SelectMany operator that functions as a replace operation.

FIG. 15 illustrates a diagram of a SelectMany operator that functions as a record/playback operation.

FIG. 16 illustrates an alternative representation of a share function.

FIG. 17 illustrates an alternative representation of a playback function.

FIG. 18 illustrates a computer-implemented processing method for observable collections.

FIG. 19 illustrates additional aspects of the method of FIG. 18.

FIG. 20 illustrates an alternative processing method for observable collections.

FIG. 21 illustrates a block diagram of a computing system operable to execute operators and policies in accordance with the disclosed architecture.

### DETAILED DESCRIPTION

The disclosed architecture begins by proving that the synchronous Iterator (“pull-based” streams) and asynchronous Subject/Observer (“push-based” streams) design patterns are mathematically duals. Leveraging this duality provides an implementation of the standard query operators for implementing the correct causality relationships between nested push-based collections for flattening nested observable collections, of which there are several possibilities to combine the nested observable collections. From this abstract duality, a concrete implementation of standard sequence operators can be derived for observable (“push-based”) collections based on a pair of IObservable and IObserver interfaces that are the mirror images of the enumerable (“pull-based”) collections defined using an IEnumerable and IEnumerator pair of interfaces. As a result of this mathematical duality concurrent asynchronous and event-driven programs can be formulated using, for example, standard query comprehensions, and other types of comprehensions.

Iterator [symbol] *Subject/Observer Duality

The notion of mathematical duality is a very powerful tool that provides “buy one, get one free” in mathematics and engineering. For example, De Morgan's law exploits the duality between conjunction && and disjunction ∥ to prove that negation! distributes over both conjunction and disjunction:

!(a&&b)==!a∥!b

!(a∥b)==!a&&!b

Another example of duality in computer science is the duality between call-by-value and call-by-name. According to one existing source, duality in category theory can be formally defined as follows:

Let Σ be any statement of the elementary theory of an abstract category. The dual of Σ can be formed as follows:

Replace each occurrence of “domain” in Σ with “codomain”, and vice versa.

Replace each occurrence of g°f=h with f°g=h

Informally, these conditions state that the dual of a statement is formed by reversing arrows and compositions.

The disclosed architecture exploits a similar mathematical duality by relating the notion of asynchronous (push-based) collections to synchronous (pull-based) collections.

Begin with the well-known iterator design pattern for enumerable collections, as embodied in the .NET framework via the pair of IEnumerable<T> and IEnumerator<T> interfaces, and in Java as Iterator<T> and Iterable<T>:

```
interface IEnumerable<T>
{
    IEnumerator<T> GetEnumerator( )
}
interface IEnumerator<T>: IDisposable
{
    bool MoveNext( )
    // throws Exception
    T Current { get; }
}
```

The push-based observable collection is obtained by systematically reversing the signatures of all the members of IEnumerable<T> and IEnumerator<T>, to obtain the following pair of dual interfaces. Only the actual IEnumerator<T> interface is dualized, and the IDisposable aspect retained when dualizing GetEnumerator to Subscribe, since the intention is only to dualize the collection aspect of enumerable collections, but keep the resource management aspect invariant across the two kinds of collections (consider IEnumerator as an intersection of a pair of a IDisposable and a pure IEnumerator interfaces). The Current property or the MoveNext method may throw an exception, which is an implicit return value, and which becomes an explicit parameter of type Exception to the OnError method in the dual interface.

```
interface IObservable<T>
{
    IDisposable Subscribe(IObserver<T> handler)
}
interface IObserver<T>
{
    void OnCompleted(bool b)
    void OnError(Exception e)
    T OnNext { set; }
}
```

The protocol for the IEnumerator<T> interface is that once MoveNext( ) has returned false, it will return false for each successive call. Hence, in the dual case, the Boolean argument can be encoded to OnCompleted as true by calling it, and as false by not calling it, instead of passing it as an actual argument in each call. For symmetry between OnNext, OnError and OnCompleted, the property OnNext is changed into a method as opposed to a property. Making these final adjustments, the following pair of interfaces are arrived at for observable collections:

```
interface IObservable<out T>
{
    IDisposable Subscribe(IObserver<T> handler)
}
interface IObserver<in T>
{
    void OnCompleted( )
    void OnError(Exception e)
    void OnNext(T value)
}
```

In other words, it has been shown that the observer and iterator design patterns are mathematical duals.

### Standard Query Operators for Observable Collections

The asynchronous nature of observable collections presents challenges in the implementation of the standard sequence operators when compared to the implementation for enumerable collections. Fortunately, the duality between observable and enumerable collections serves as a guide towards the correct implementation.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

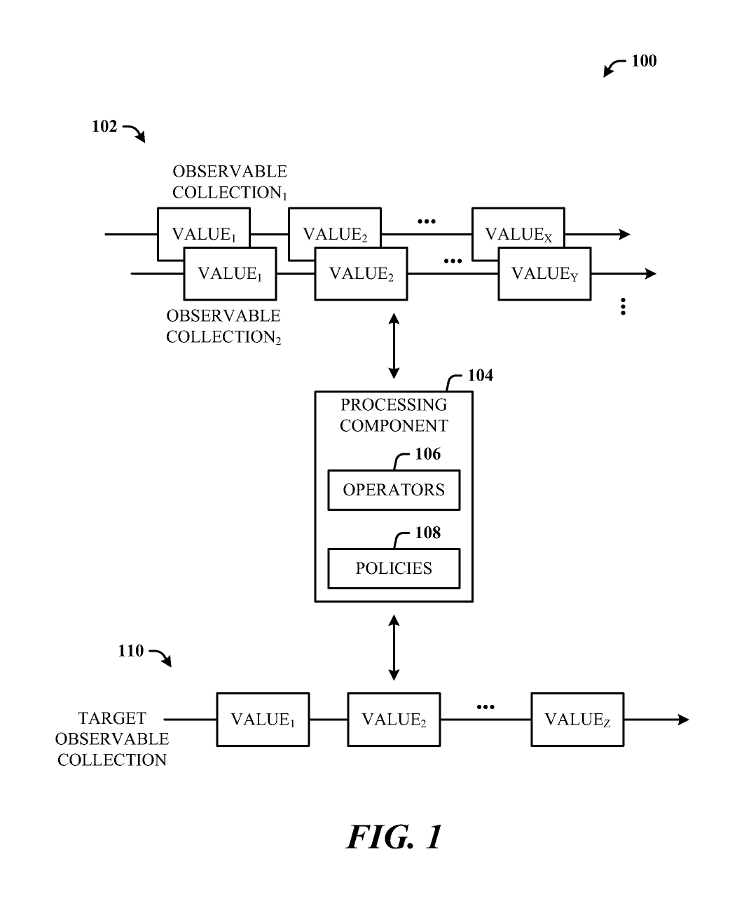

FIG. 1 illustrates a computer-implemented processing system 100 for observable collections in accordance with the disclosed architecture. The system 100 includes one or more observable collections 102 of values (e.g., asynchronous), and a processing component 104 that applies one or more operators 106 and policies 108 to the one or more observable collections 102 to control composition of a target observable collection 110.

The operators 106 are based on the dual relationship established between the observer design pattern and the iterator design pattern. The processing component 104 includes an operator that applies a function to an asynchronous value to create an inner observable collection. The processing component 104 includes an operator that non-deterministically merges asynchronous values of multiple observable collections to the target observable collection 110, while maintaining a causality relationship of the values. The processing component 104 includes an operator that propagates values from a source observable collection (e.g., one of the observable collections 102) to the target observable collection 110 until an asynchronous value occurs on a control observable collection. The processing component 104 can also include an operator that allows values of an observable collection to be shared within one or more subscribers, and an operator that drops a first value of an observable collection based on another value. The processing component 104 also includes an operator that transitions between a nested observable collection to another nested observable collection.

The processing component 104 includes a policy that broadcasts values based on ignoring asynchronous values of one observable collection relative to termination of another observable collection, and a policy that terminates an observable collection in response to creation of another observable collection. The processing component 104 includes policies that record asynchronous values of a next observable collection until a previous observable collection terminates, and plays back the recorded values according to time information associated with the arrival of the values (e.g., on the first observable collection).

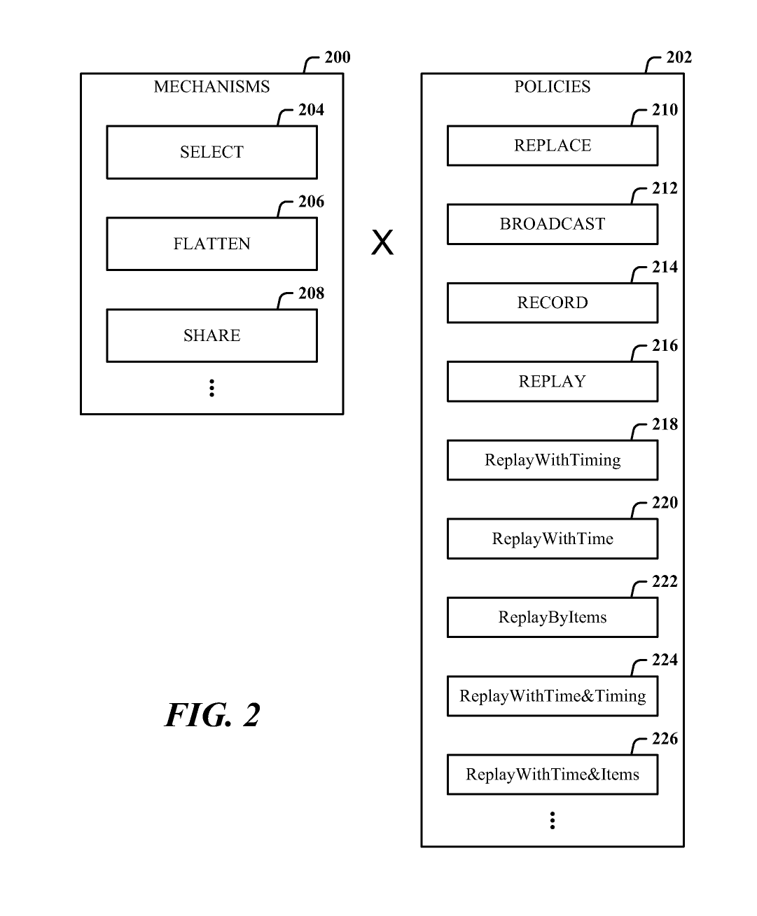

FIG. 2 illustrates mechanisms 200 for composing observable collections and policies 202 that can apply to each mechanism. The mechanisms 200 include Select 204, Flatten 206, and Share 208, for example. Select 204 applies a selector function f to each element of the source observable collection. Flatten 206 merges values of incoming collections to a target observable collection. Share 208 allows notifications on a single observable collection to be shared within a context of a function.

One or more of the policies 202 can be applied to each of the mechanisms (as indicated by the “X”). The policies 202 include, but are not limited to, a Replace policy 210, Broadcast policy 212, Record policy 214, Replay policy 216, and variations on the Replay policy 216. The policy variations can include, but are not limited to, recording and replay, for example. Policies such as a ReplayWithTiming policy 218, ReplayWithTime policy 220, ReplayByItems policy 222, ReplayWithTime&Timing policy 224, and ReplayWithTime&Items policy 226, for example, represent variations that can be employed in combination with Replay. Although not illustrated, variations can also be applied to Broadcast, such as broadcast based on time, timing, and so on.

The Replace policy 210 forwards a previous collection until a next collection starts. The Broadcast policy 212 broadcasts values to one or more observers. The Record policy 214 records (buffers) values of an observable collection and the Replay policy 216 plays back the recorded values.

The Record policy 214 and Replay policy 216 can operate in many different ways. For example, if values are recorded with timing differential information that indicates the time between values when recorded. The ReplayWithTiming policy 218 replays the values according to the timing differential information (“timing”) when recorded.

Replay can also be according to a specific time by using the ReplayWithTime policy 220. Replay can also be according to item count by using the ReplayByItems policy 222. Further combinations can include replay initiated at a specific time, and then according to the recorded timing differential information, by using the ReplayWithTiming&Time policy 224. A still further combination can include replaying values at a specific time, and then by item count, by using the ReplayWithTime&Items policy 226.

As previously indicated, other variations can include a RecordByItem policy (not shown) that records a finite number of values, and a RecordWithTiming policy (not shown) that records the timing information (e.g., of time arrival) when recording the values, for example.

Note that there can be many implementations of Select, Flatten, and Share, for example, not all of which are specifically illustrated but follow from the described illustrations and embodiments.

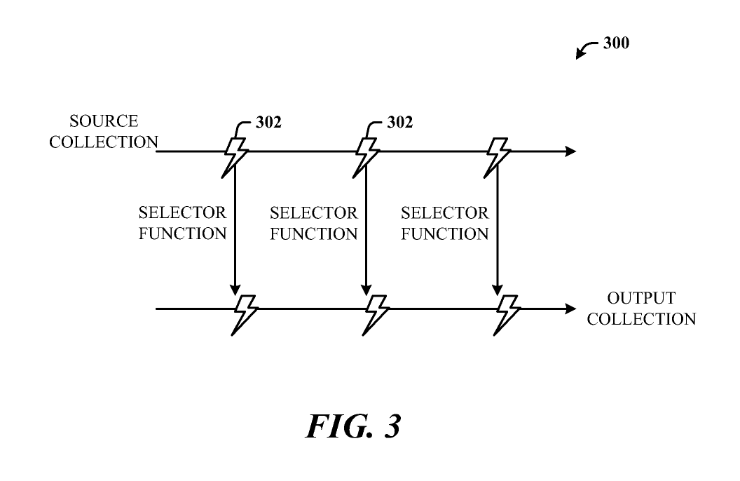

FIG. 3 illustrates a diagram 300 that represents a Select operator for observable collections. The Select operator for observable collections observes the source stream (collection), and whenever the source collection (SRC) is notified of a next value, the source collection applies a selector function ƒ to each element 302 of the source collection to produce each subsequent result value and subsequently notifies its own (source collection) observers.

```
      IEnumerable<S> Select<T, S>(this IEnumerable<T> src,
Func<T,S> f)
      {
        foreach(var t in src)
        {
          var s = f(t); yield return s;
        }
      }
```

The above pseudocode uses the syntactic sugar of foreach loops and yield return iterators, which a C# compiler can expand into calls to GetEnumerator and MoveNext( )/Current, and a complex state-machine that maintains all control-flow and variable state across interruptions, respectively. Hence, the actual code generated by the compiler is much more complex.

For observable collections of type IObserver<T>, the implementation of Select immediately returns a new target observable of type IObserver<S> that when an observer of type is attached to the target, a new observer of IObserver<T> is attached to the original source. When that observer is notified with a value of type T, it will try to run the selector on the value, and if successful, notify the transformed value of type S, to the target observable collection. If the selector throws an exception or if the source collection signals OnError, the exception is immediately thrown to the target observable collection. If the source observable collection sends a Dispose message, the new observer is removed from the source collection. The pseudocode implementing the Select function on an observable collection can appear as the following:

```
IObservable<S> Select<T, S>(this IObservable<T> src, Func<T,S>
f)
{
  return new IObservable<S> // target
  {
    IDisposable Subscribe(IObserver<S> observer)
    {
      IDisposable detach = null;
      detach = src.Subscribe(
        new IObserver<T>
        {
          void OnError( ){ detach( ); }
          void OnNext(T t)
          {
            S s;
            try { s = f(t); }catch(Exception e){
observer.OnError(e); return; }
            observer.OnNext(s);
          }
          void OnError(Exception e) { observer.OnError(e); }
        });
      return detach;
    }
  }
}
```

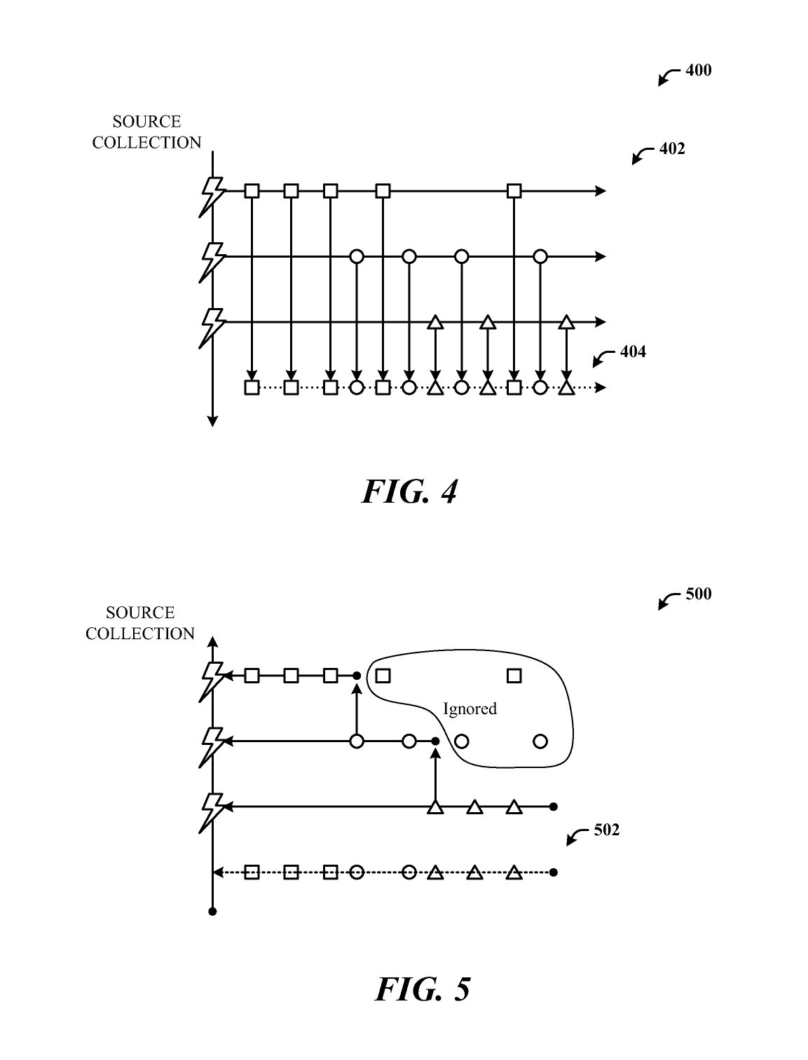

FIG. 4 illustrates a diagram 400 that represents the effect of a Flatten operator for observable collections. The source observable collection (represented vertically) can be a single collection of values or a combination of multiple different collections of associated different values. Here, the source observable collection includes three inner observable collection 402 (represented horizontally). A top inner observable collection includes five values (□) pushed to an observer (or receiver), a middle inner observable collection includes four values (∘) pushed to an observer, and a bottom inner observable collection includes three values (Δ) being pushed to an observer. As illustrated, the top inner observable collection began pushing its values first, followed by values observed on the middle inner observable collection, and lastly, by values observed on the bottom inner observable collection.

A naïve observable flatten operation supports the implementation of operators (e.g., LINQ query operators), and is shown as IObservable<T> Flatten(this IObservable<IObservable<T>> src). The push nature of observable collections makes this non-trivial.

FIG. 5 illustrates a diagram 500 for a replace strategy where a previous observable collection is forwarded until a next observable collection starts. An alternative implementation of Flatten is to terminate the previous subscription when a subsequent value occurs on a next subscription. This ensures that the observer does not receive an interleaving of notifications from several concurrent observers, but will lose all values from the previous subscription that are sent after the subsequent collection starts. Other alternatives are possible.

Here, the values of each inner collection are grouped when pushed on the target (merged) observable collection. This grouping is obtained by merging the values of a next inner collection (e.g., middle inner collection) only after the values of the previous inner collection (e.g., top inner collection) have been merged based on termination of the associate inner collection. This sorted merge is shown on the target collection 502, where three values from the top inner collection are merged prior to termination of the top inner collection, followed by two values of the middle inner collection following termination of the top inner collection, followed by three values of the bottom inner collection following termination of the middle inner collection.

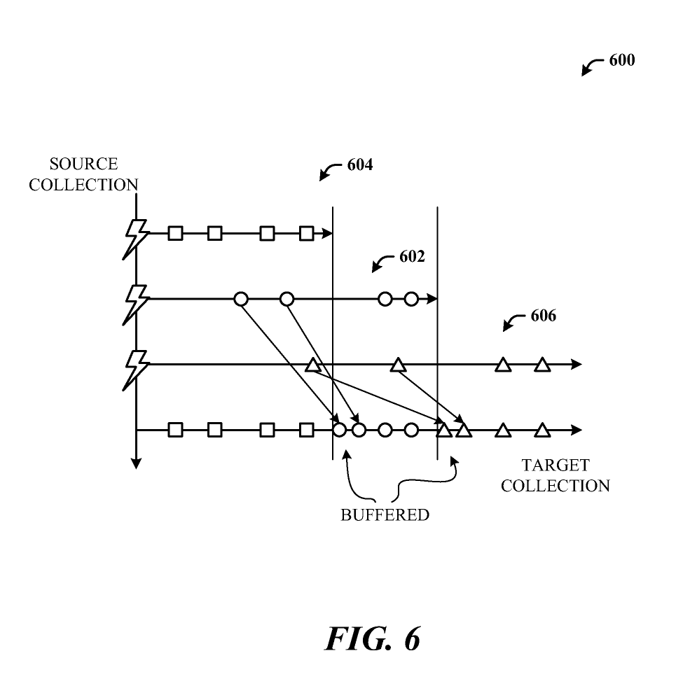

FIG. 6 illustrates a diagram 600 of yet another approach to flattening nested observable collections by buffering subsequent collections until the previous collections have terminated. The values of each inner collection are buffered. Here, two values of a middle inner observable collection 602 are buffered while the values are still occurring in a top inner observable collection 604, and two values of a bottom inner observable collection 606 are buffered while the values are still occurring in the middle inner observable collection 602. The buffer for the middle inner observable collection 602 buffers its values until notification of termination is received from the top inner observable collection 604. Similarly, the buffer for the bottom inner observable collection 606 buffers its values until notification of termination is received from the middle inner observable collection 602.

In an alternative implementation, while processing the top values of the top inner collection 604, if a value comes in on the middle inner collection 602, processing immediately jumps to the middle inner collection 602 regardless of values of the top inner collection 604. The values of the top inner collection 604 (previous) are forgotten (or lost). Still alternatively, the buffered values can be saved with relative timing information (timing) and then be pushed out according to the relative timing information. In yet another alternative implementation, only values that occurred during a previous time period (e.g., last fifteen minutes) or according to a count (e.g., last fifty) are buffered.

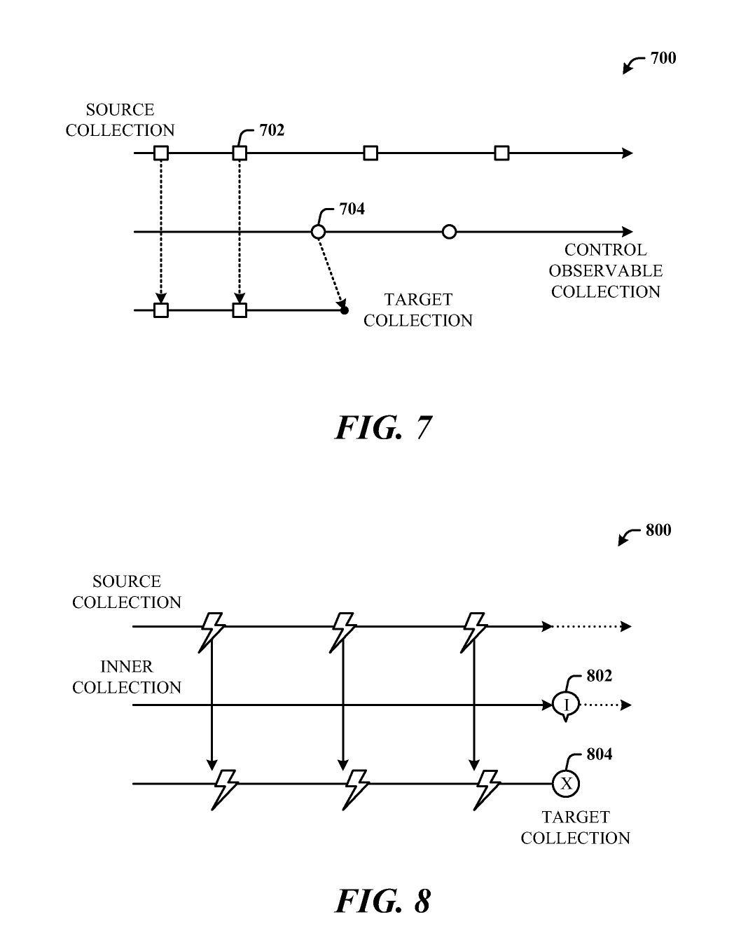

FIG. 7 illustrates a diagram 700 for an Until operator that can be used to implement the above mentioned strategies for flattening nested observable collections. Each requires a change in behavior once a particular “control” value is observed. Values (values) 702 from the source observable collection are forwarded to a target collection until a first notification (value 704) on the control observable collection. This operator target=source.Until (control) is used as a building block in realizing the various behaviors (behaving one way, until some value is produced).

Referring back to FIG. 5, the merging implementation is modified by inserting the Until preemption operator IObservable<T> Until<T,S>(this IObservable<T> src, IObservable<S> control) that propagates notifications from the source observable collection to the target observable collection 502, as represented in diagram 500, until a first notification occurs on the control collection (not shown) to implement the replacement strategy.

FIG. 8 illustrates a diagram 800 for handling errors. The semantic is if an error 802 occurs on the source and/or inner observable collections, the error 802 is propagated to the target collection, in which case an OnError( ) 804 is sent to the target observable collection and detaches from both the source and control collections. In other words, errors get eagerly distributed, and all collections terminate.

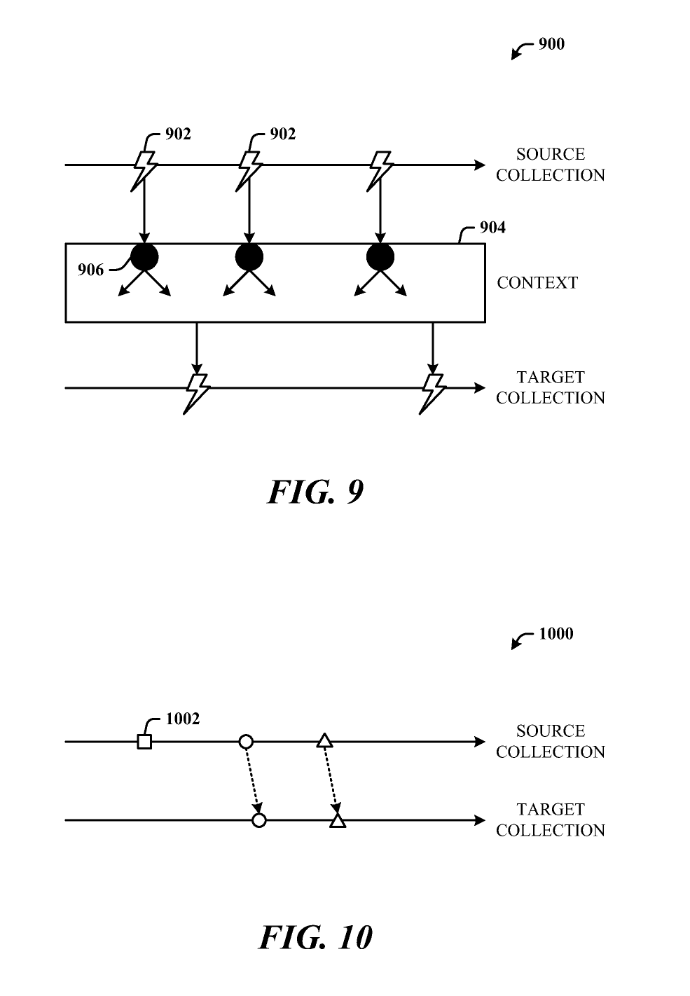

FIG. 9 illustrates a diagram 900 for a Share operator. The Share operator, IObservable<S> Share<T,S>(this IObservable<T> src, Func<IObservable<T>, IObservable<S>> context), allows notifications 902 on a single observable collection (e.g., the source collection) to be shared within a context 904 of a function by multiple observers (not shown) using a splitter function 906 for duplicating and providing copies of the input to the observers. A notification collection (embodied as part of the context 904) only sends one value to the target collection. In other words, a single subscription gets duplicated in the context 904 for use (shared) by others (observers), yet this duplication in the context 904 is not forwarded to the target collection. A new observer in the context 904 does not receive past information that had been submitted—only information moving forward.

FIG. 10 illustrates a diagram 1000 for a Next operator. The signature of the Next operation is IObservable<S> Next(this IObservable<T>), and forwards notifications from the source collection to the target collection after dropping the very first notification 1002 on the source observable collection (source collection).

Using all these operators, the replacing version of Flatten for observable collections can be defined via the following intimidating expressions (referred to collectively as a Tarzan algorithm) that terminate each nested collection as soon as a next nested collection is produced:

```
      IObservable<S> FlattenReplace<S>(this
IObservable<IObservable<S>> src)
      {
          return src.ShareBroadcast(xss =>
            xss.Select(xs =>
              xs.Until(xss.Next( )))).
          Flatten ( );
      }
```

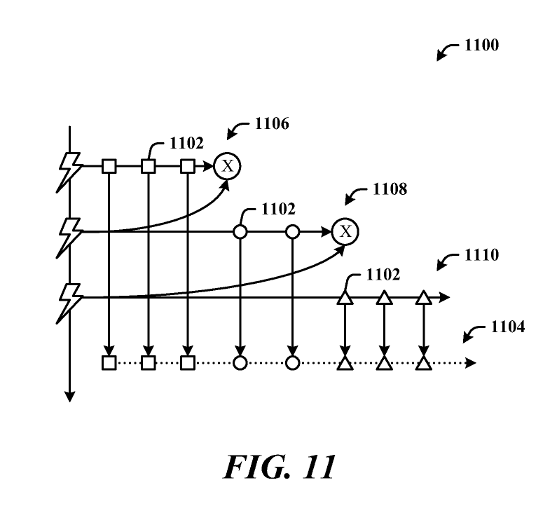

FIG. 11 illustrates a diagram 1100 for operation of the disclosed Tarzan algorithm. The Tarzan algorithm allows an observable collection to “swing” from one nested (inner) observable collection to another. The invariant nature of observable collections means that values 1102 can be moved backward or forward in time as long as causality is preserved. Here, the Until operator adjusts the values 1102 on the inner observable collections such that merger to the target collection 1104 maintains causal order (causality relationship). Thus, merger to the target collection is likewise according to the causal order. When values 1102 in a top inner observable collection 1106 terminate, flow follows the values in the middle inner collection 1108, and then the values of the bottom inner observable collection 1110. The algorithm also allows flow from the bottom inner collection 1110 to the middle inner collection 1108 and from the middle inner collection 1108 to the top inner collection 1106.

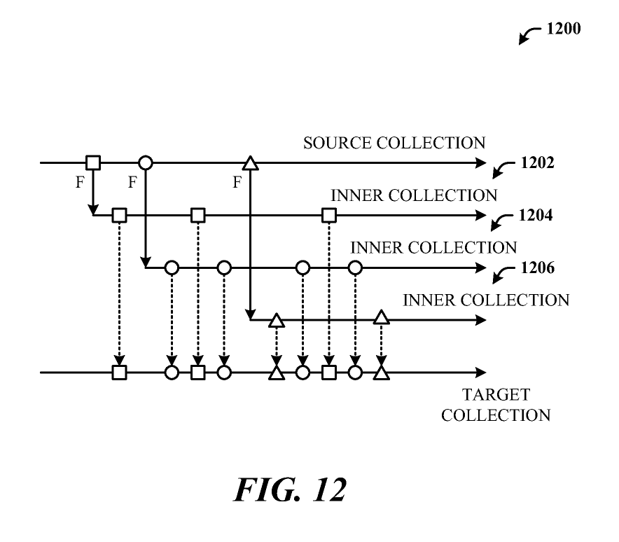

FIG. 12 illustrates a diagram 1200 of a more specific implementation of a SelectMany operator. As a new value occurs on the source observable collection, the function F is applied to create a new inner observable collection (e.g., a top inner collection 1202). A target observable collection interleaves values from each inner collection, such as the top inner observable collection 1202, a middle inner observable collection 1204, and a bottom inner observable collection 1206. Relative ordering (causality) is maintained. In other words, the function F creates a new inner collection from each seed value appearing on the source collection.

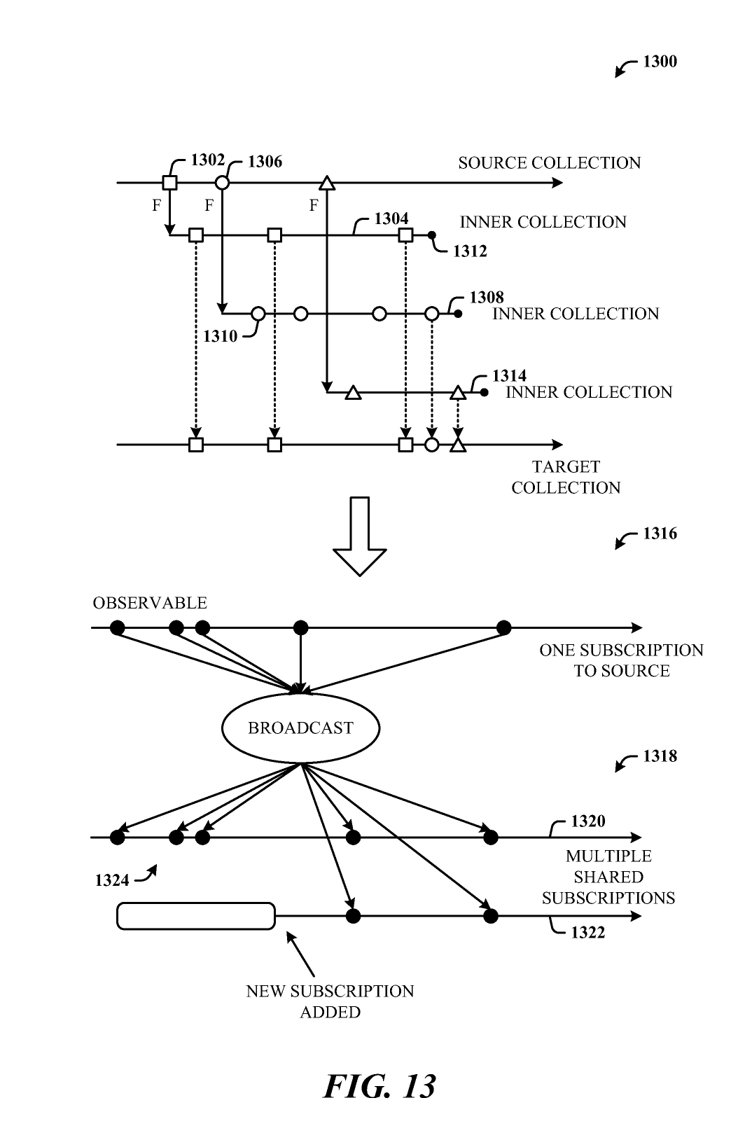

FIG. 13 illustrates a diagram 1300 of a SelectMany operator that functions as a broadcast operation. Here, values on a next inner collection are ignored until the previous inner collection terminates. Concatenation of some values occurs from each inner collection (e.g., dropping at the beginning). Here, when a first value 1302 occurs on the source collection, the function F automatically creates a top inner collection 1304. Three values occur in the top inner collection 1304 and are merged to the target collection even though a second value 1306 occurs on the source collection. The function F also automatically creates a middle inner collection 1308, but values 1310 occurring on the middle inner collection 1308 are not merged to the target stream until the top inner collection 1304 terminates at 1312. Similar behavior occurs to events of a bottom inner stream 1314 relative to the middle inner stream 1308.

The values are broadcast for sharing to other collections 1318, an existing subscriber 1320 that receives all values of the source and a new subscriber 1322 that only receives values occurring after the subscription time. Values 1324 prior to the subscription time are not shared.

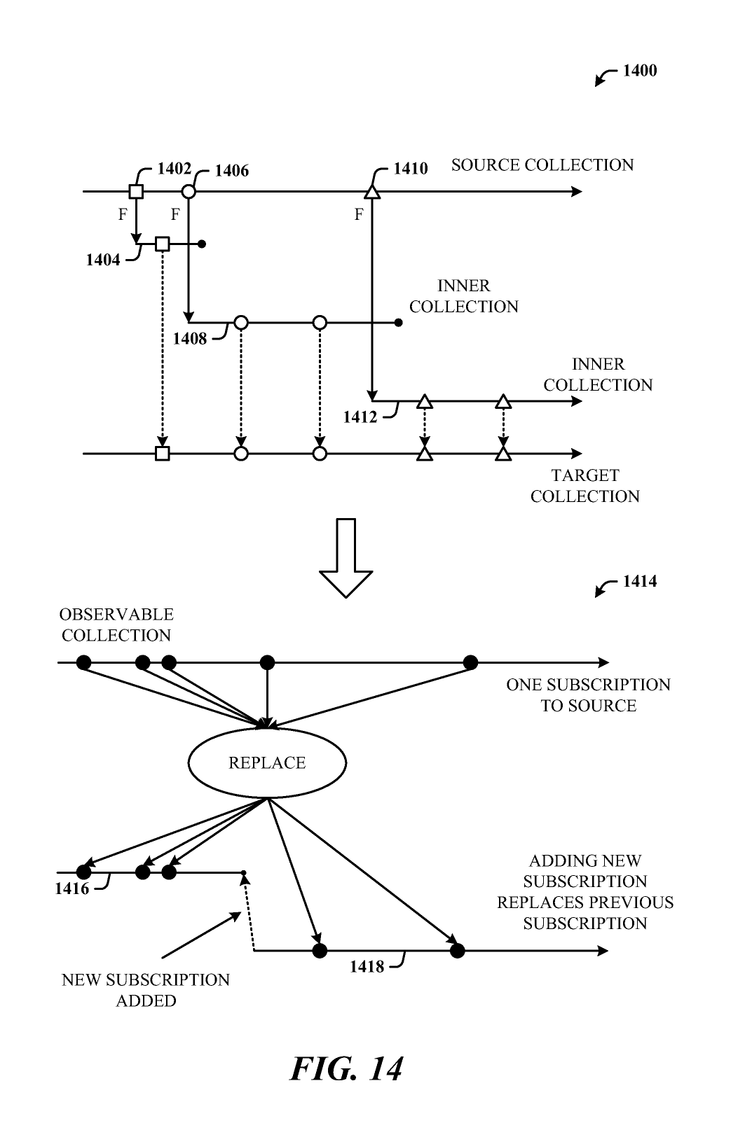

FIG. 14 illustrates a diagram 1400 of a SelectMany operator that functions as a replace operation. This operator unsubscribes or terminates a previous inner collection as soon as the next inner collection is created. When a first value 1402 occurs, a first inner collection 1404 is created in response to a function F applied to the value 1402. The first inner collection 1404 then continues, and values of the first inner collection 1404 are merged to the target collection. When a second value 1406 occurs in the source collection, a second inner collection 1408 is created and the first inner collection 1404 is terminated. Values of the second inner collection 1408 are then merged to the target collection. When a third value 1410 occurs in the source collection, a third inner collection 1412 is created and the second inner collection 1408 is terminated. Values of the third inner collection 1412 are then merged to the target collection. In other words, the target observable collection is a concatenation of some values of the inner collections (e.g., second inner collection 1408, third inner collection 1412).

The values are broadcast to an existing subscriber 1416 that receives the values of the source collection. A new subscriber 1418 replaces the existing subscriber 1416 when the new subscription is added; however, the new subscriber does not receive values prior to the subscription time.

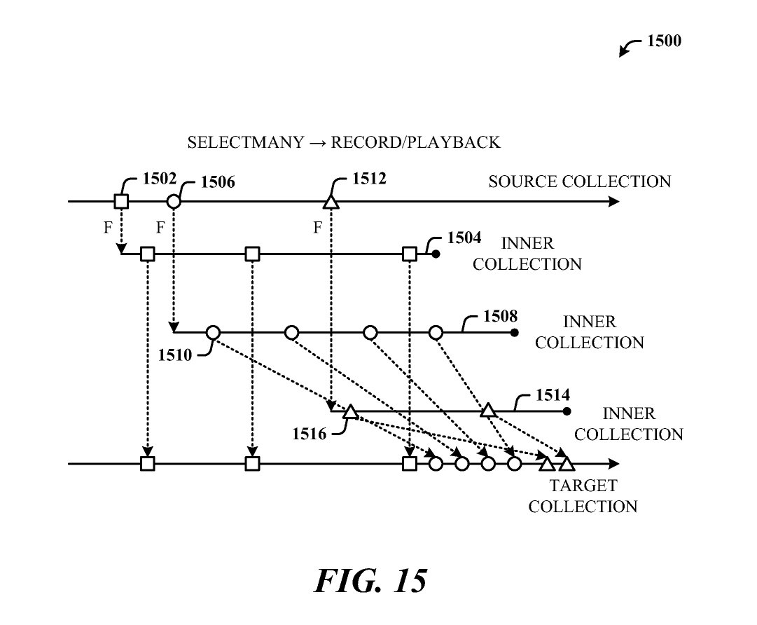

FIG. 15 illustrates a diagram 1500 of a SelectMany operator that functions as a record/playback operation. Generally, this results in buffering (recording) a next inner collection until the previous inner collection terminates, and playback of variant buffers with the same time interval between arrivals. Concatenation of all values from each inner collection occurs (dropping no values/maintaining time intervals).

More specifically, when a first value 1502 occurs on the source collection, the function F is applied to the first value 1502 to create a first inner collection 1504. The values occurring on the first inner collection 1504 are merged to the target collection, and the temporal information associated with each value arrival in that collection. Concurrently, when a second value 1506 occurs on the source observable collection, a second inner collection 1508 is created using the function F and, the second inner collection 1508 and temporal information are buffered. When the first inner collection 1504 terminates, the buffered second inner collection 1508 is played back and its associated values 1510 are merged to the target collection using the recorded temporal information.

Similarly, while the second inner collection 1508 plays, a third source value 1512 occurs, on the source collection. Application of the function F creates a third inner collection 1514 with arrival interval times for its values 1516. The third inner collection 1514, values 1516 and associated time interval information (also referred to a time differential information or “timing”) is recorded until the second inner observable collection 1508 terminates. Thereafter, the third inner collection 1514, values 1516, and time interval information is played back to the target observable collection.

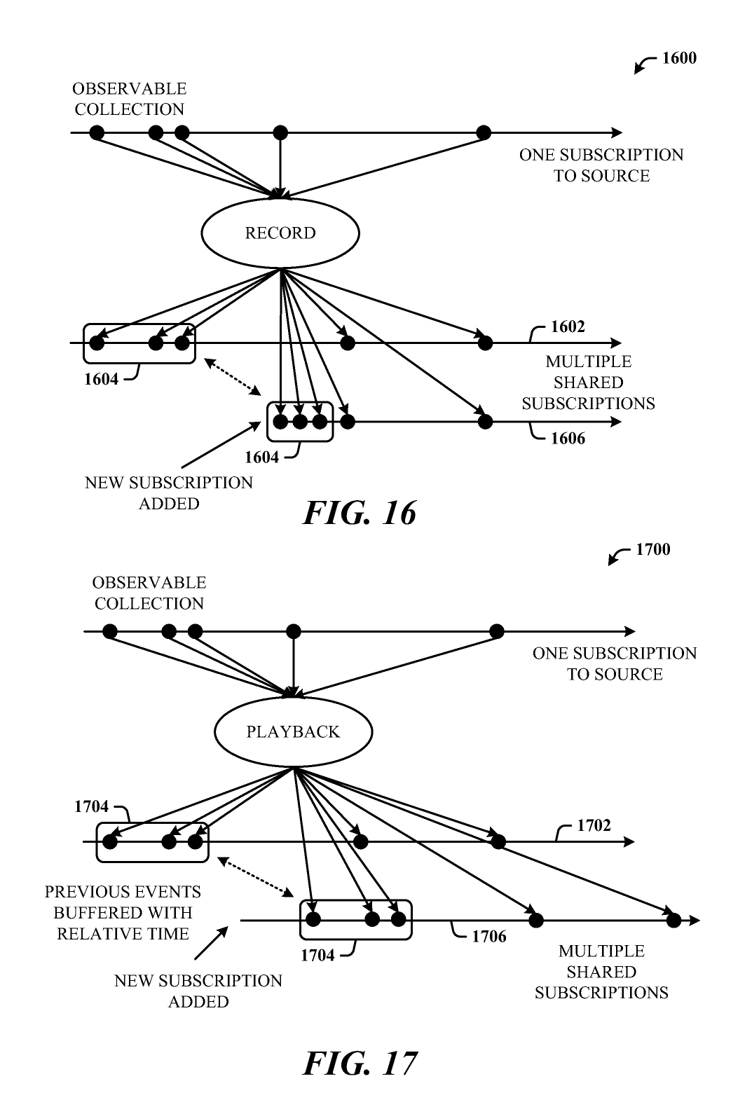

FIG. 16 illustrates an alternative representation 1600 of a share function. Here, a single subscription is to a source observable collection that includes multiple values. The values are broadcast to an existing subscriber 1602 that receives the values of the source collection and records some values 1604. When a new subscription 1606 is added, the recorded values 1604 are applied to the new subscription 1606 as well as other values that occur at the same time or thereafter relative to the subscription time. The recorded values 1604 are not recorded with relative time information.

FIG. 17 illustrates an alternative representation 1700 of a playback function. Here, a single subscription is to a source observable collection that includes multiple values. The values are broadcast to an existing subscriber 1702 that receives the values of the source and records some values 1704 with the relative time information. When a new subscription 1706 is added, the recorded values 1704 and relative time information of the existing subscription 1702 are applied to the new subscription 1706 as well as relative new values occurring in the existing subscription 1702. In other words, the values are played back according to the same times as received by the existing subscription 1702.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

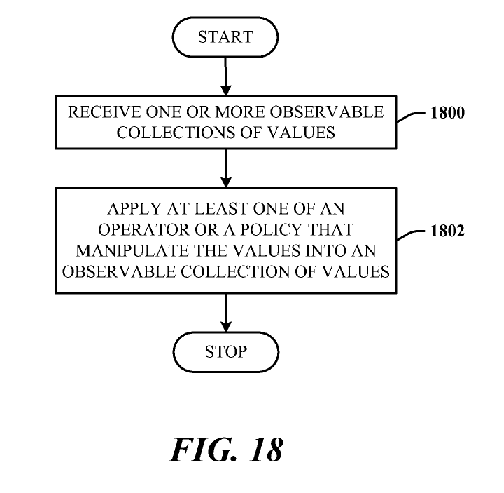

FIG. 18 illustrates a computer-implemented processing method for observable collections. At 1800, one or more observable collections of values are received. At 1802, one or more operators and policies are applied that manipulate the values into an observable collection of values.

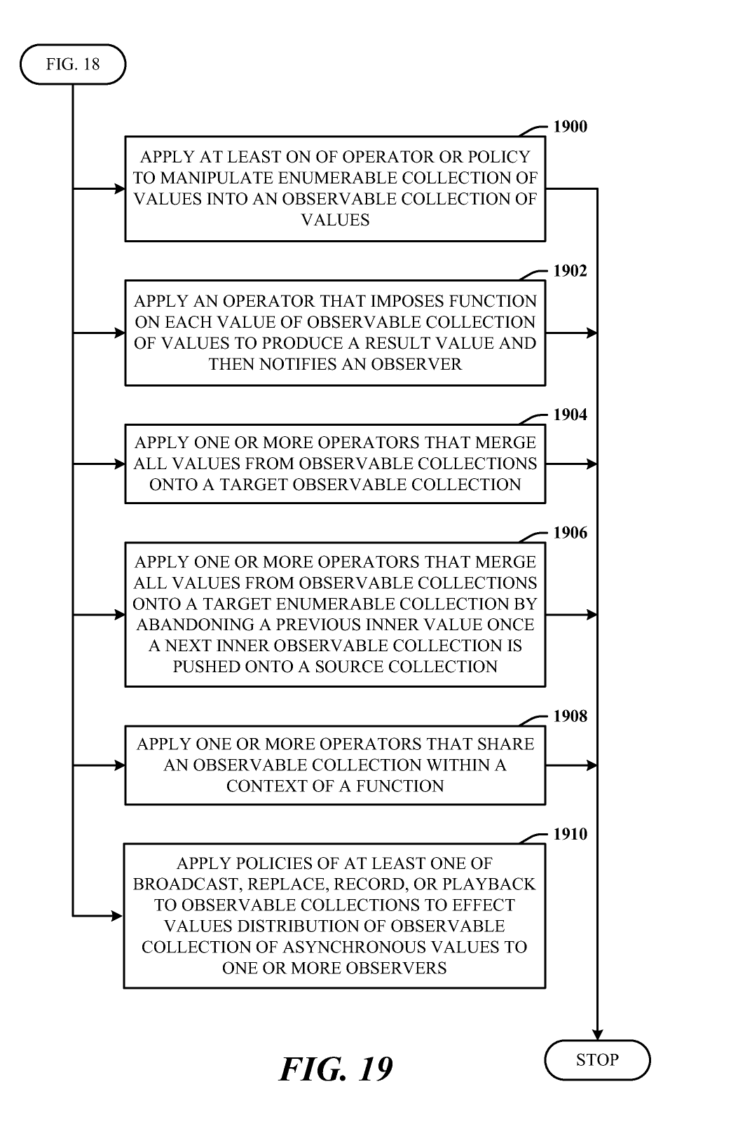

FIG. 19 illustrates additional aspects of the method of FIG. 18. At 1900, the one or more operators and policies are applied to manipulate the enumerable collection of synchronous values into an observable collection of asynchronous values. At 1902, an operator is applied that imposes a function on each value of the observable collection of values to produce a result value and then notifies an observer. At 1904, one or more operators are applied that merge all values from the observable collections onto a target observable collection. At 1906, one or more operators are applied that merge all values from the observable collections onto a target enumerable collection by abandoning a previous inner value once a next inner observable collection is pushed onto a source collection. At 1908, one or more operators are applied that share an observable collection within a context of a function. At 1910, policies are applied of at least one of broadcast, replace, record, or playback to the observable collections to effect values distribution of the observable collection of asynchronous values to one or more observers.

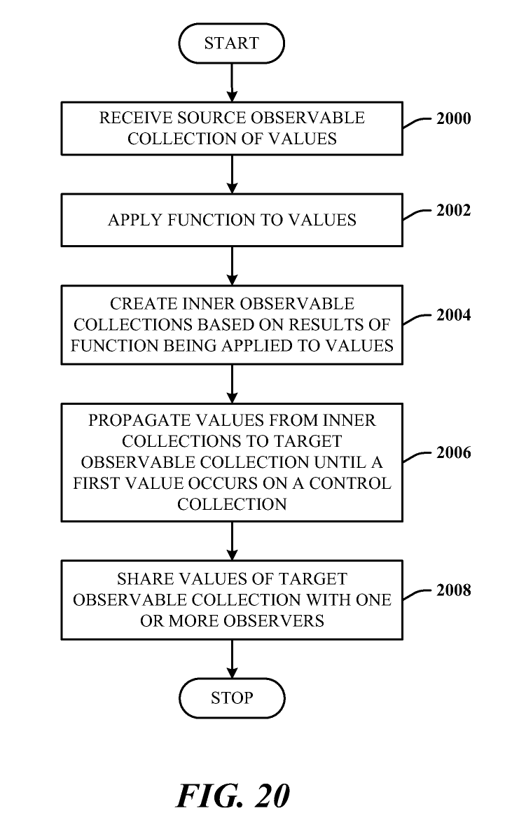

FIG. 20 illustrates an alternative processing method for observable collections. At 2000, a source observable collection of asynchronous values is received. At 2002, a function is applied to the values. At 2004, inner observable collections are created based on results of the function being applied to the values. At 2006, values are propagated from the inner collections to a target observable collection until a first asynchronous value occurs on a control collection. At 2008, the values of the target observable collection are shared with one or more observers. Additionally, policies of at least one of broadcast, replace, record, or playback can be applied to values of the target observable collections as part of sharing the values.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

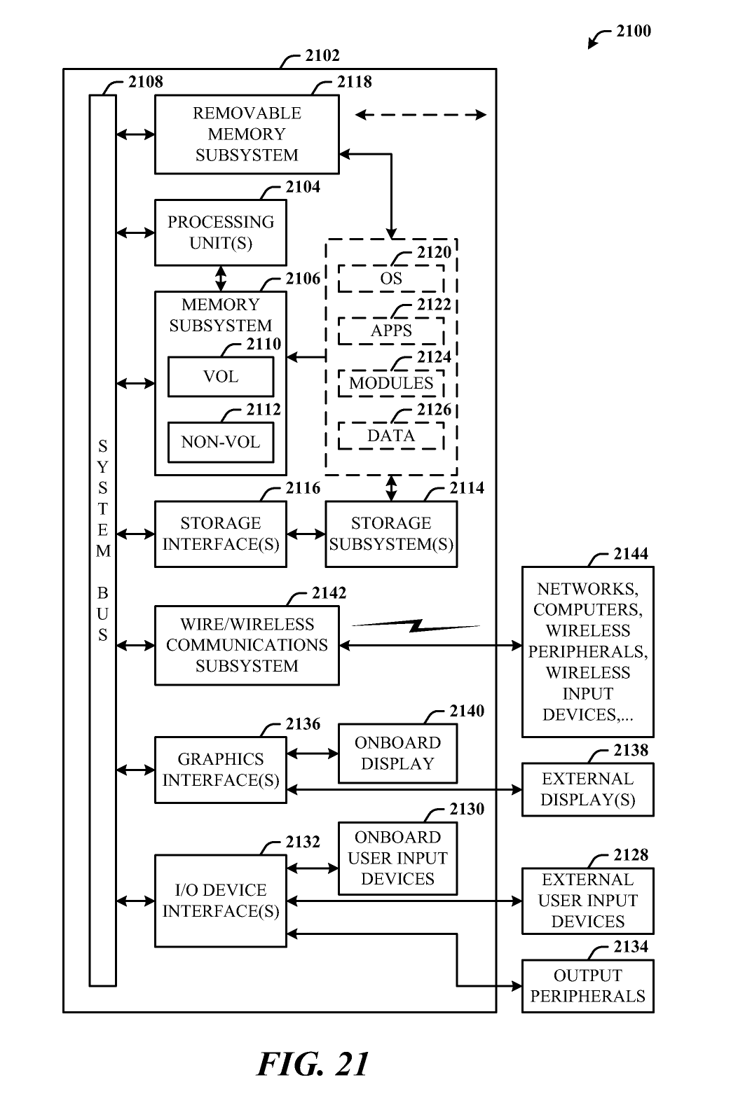

Referring now to FIG. 21, there is illustrated a block diagram of a computing system 2100 operable to execute operators and policies in accordance with the disclosed architecture. In order to provide additional context for various aspects thereof, FIG. 21 and the following description are intended to provide a brief, general description of the suitable computing system 2100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 2100 for implementing various aspects includes the computer 2102 having processing unit(s) 2104, a system memory 2106, and a system bus 2108. The processing unit(s) 2104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 2106 can include volatile (VOL) memory 2110 (e.g., random access memory (RAM)) and non-volatile memory (NON-VOL) 2112 (e.g., ROM, EPROM, EEPROM, etc.). A basic input/output system (BIOS) can be stored in the non-volatile memory 2112, and includes the basic routines that facilitate the communication of data and signals between components within the computer 2102, such as during startup. The volatile memory 2110 can also include a high-speed RAM such as static RAM for caching data.

The system bus 2108 provides an interface for system components including, but not limited to, the memory subsystem 2106 to the processing unit(s) 2104. The system bus 2108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 2102 further includes storage subsystem(s) 2114 and storage interface(s) 2116 for interfacing the storage subsystem(s) 2114 to the system bus 2108 and other desired computer components. The storage subsystem(s) 2114 can include one or more of a hard disk drive (HDD), a magnetic floppy disk drive (FDD), and/or optical disk storage drive (e.g., a CD-ROM drive DVD drive), for example. The storage interface(s) 2116 can include interface technologies such as EIDE, ATA, SATA, and IEEE 1394, for example.

One or more programs and data can be stored in the memory subsystem 2106, a removable memory subsystem 2118 (e.g., flash drive form factor technology), and/or the storage subsystem(s) 2114 (e.g., optical, magnetic, solid state), including an operating system 2120, one or more application programs 2122, other program modules 2124, and program data 2126.

The one or more application programs 2122, other program modules 2124, and program data 2126 can include the entities and components of system 100 of FIG. 1, the mechanisms and policies of FIG. 2, the diagrams of FIGS. 2-17, and the methods represented in the flow charts of FIGS. 18-20, for example.

Generally, programs include routines, methods, data structures, other software components, etc., that perform particular tasks or implement particular abstract data types. All or portions of the operating system 2120, applications 2122, modules 2124, and/or data 2126 can also be cached in memory such as the volatile memory 2110, for example. It is to be appreciated that the disclosed architecture can be implemented with various commercially available operating systems or combinations of operating systems (e.g., as virtual machines).

The storage subsystem(s) 2114 and memory subsystems (2106 and 2118) serve as computer readable media for volatile and non-volatile storage of data, data structures, computer-executable instructions, and so forth. Computer readable media can be any available media that can be accessed by the computer 2102 and includes volatile and non-volatile internal and/or external media that is removable or non-removable. For the computer 2102, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 2102, programs, and data using external user input devices 2128 such as a keyboard and a mouse. Other external user input devices 2128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 2102, programs, and data using onboard user input devices 2130 such a touchpad, microphone, keyboard, etc., where the computer 2102 is a portable computer, for example. These and other input devices are connected to the processing unit(s) 2104 through input/output (I/O) device interface(s) 2132 via the system bus 2108, but can be connected by other interfaces such as a parallel port, IEEE 1394 serial port, a game port, a USB port, an IR interface, etc. The I/O device interface(s) 2132 also facilitate the use of output peripherals 2134 such as printers, audio devices, camera devices, and so on, such as a sound card and/or onboard audio processing capability.

One or more graphics interface(s) 2136 (also commonly referred to as a graphics processing unit (GPU)) provide graphics and video signals between the computer 2102 and external display(s) 2138 (e.g., LCD, plasma) and/or onboard displays 2140 (e.g., for portable computer). The graphics interface(s) 2136 can also be manufactured as part of the computer system board.

The computer 2102 can operate in a networked environment (e.g., IP-based) using logical connections via a wired/wireless communications subsystem 2142 to one or more networks and/or other computers. The other computers can include workstations, servers, routers, personal computers, microprocessor-based entertainment appliances, peer devices or other common network nodes, and typically include many or all of the elements described relative to the computer 2102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 2102 connects to the network via a wired/wireless communication subsystem 2142 (e.g., a network interface adapter, onboard transceiver subsystem, etc.) to communicate with wired/wireless networks, wired/wireless printers, wired/wireless input devices 2144, and so on. The computer 2102 can include a modem or other means for establishing communications over the network. In a networked environment, programs and data relative to the computer 2102 can be stored in the remote memory/storage device, as is associated with a distributed system. It will be appreciated that the network connections shown are exemplary and other means of establishing a communications link between the computers can be used.

The computer 2102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented processing system for observable collections, comprising:
one or more observable collections of values; and
a processing component that applies operators and policies to the one or more observable collections to control composition of a target observable collection.

2. The system of claim 1, wherein the operators are based on a dual relationship established between an observer design pattern and an iterator design pattern.

3. The system of claim 1, wherein the processing component includes an operator that applies a function to an asynchronous value to create an inner observable collection.

4. The system of claim 1, wherein the processing component includes an operator that non-deterministically merges asynchronous values of multiple observable collections to the target observable collection while maintaining a causality relationship of the values.

5. The system of claim 1, wherein the processing component includes an operator that propagates values from a source observable collection to the target observable collection until an asynchronous value occurs on a control observable collection.

6. The system of claim 1, wherein the processing component includes an operator that allows values of an observable collection to be shared within one or more subscribers.

7. The system of claim 1, wherein the processing component includes an operator that drops a first value of an observable collection based on a value of another collection value.

8. The system of claim 1, wherein the processing component includes an operator that transitions between a nested observable collection to another nested observable collection.

9. The system of claim 1, wherein the processing component includes a policy that broadcasts values based on ignoring asynchronous values of one observable collections relative to termination of another observable collection.

10. The system of claim 1, wherein the processing component includes a policy that terminates an observable collection in response to creation of another observable collection.

11. The system of claim 1, wherein the processing component includes policies that record asynchronous values of a next observable collection until a previous observable collection terminates, and plays back the recorded values according to time information associated with the arrival of the values.

12. A computer-implemented processing method for observable collections, comprising:
receiving one or more observable collections of values; and
applying at least one of an operator or a policy that manipulate the values into an enumerable collection of values.

13. The method of claim 12, further comprising applying the at least one of an operator or a policy to manipulate the enumerable collection of values into an observable collection of values.

14. The method of claim 12, further comprising applying an operator that imposes a function on each value of the observable collection of values to produce a result value and then notifies an observer.

15. The method of claim 12, further comprising applying one or more operators that merge all values from the observable collections onto a target observable collection.

16. The method of claim 12, further comprising applying one or more operators that merge all values from the observable collections onto a target enumerable collection by abandoning a previous inner observable collection once a next inner observable collection is pushed onto a source observable collection.

17. The method of claim 12, further comprising applying one or more operators that share an observable collection within a context of a function.

18. The method of claim 12, further comprising applying policies of at least one of broadcast, replace, record, or playback to the observable collections to effect values distribution of the observable collection of asynchronous values to one or more observers.

19. A computer-implemented processing method for observable collections, comprising:
receiving a source observable collection of asynchronous values;
applying a function to the values;
creating inner observable collection based on results of the function being applied to the values;
propagating values from the inner observable collections to a target observable collection until a first asynchronous value occurs on a control observable collection; and
sharing the values of the target observable collection with one or more observers.

20. The method of claim 19, further comprising applying policies of at least one of broadcast, replace, record, or playback to values of the target observable collection as part of sharing the asynchronous values.
